(19) United States
(12) Patent Application Publication
(10) Pub. No.: US 2009/0114598 A1
(43) Pub. Date: May 7, 2009

(54) Water Softening Device and Method

(76) Inventors: Cornelis Gerhard van Kralingen, Vlaardingen (NL); Hank Robert Reinhoudt, Vlaardingen (NL); Harm Jan Riksen, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/795,998

(22) PCT Filed: Dec. 21, 2005
(86) PCT No.: PCT/EP2005/014060

§ 371 Date: Jun. 26, 2008

(30) Foreign Application Priority Data
Jan. 27, 2005 (EP) 05075218.7

(51) Int. Cl. C02F 5/00; B01J 47/08; C02F 1/42; C02F 103/00

(52) U.S. Cl. 210/676; 210/190

(57) ABSTRACT

The present invention provides a water softening device for application in a household appliance comprising a flow-through capacitor for the production of wash amplified water (WAW) from tap water, having less than 5° FH, being suitable for use in said appliance when the device is in operation; the configuration of the device is such that the capacitor can be regenerated, whereby no added substances are used. Said washing machine being suitable for use with low environmental impact detergent products.

### FIELD OF THE INVENTION

The present invention relates to the field of fabric cleaning methods. The invention is concerned with a water softening device for application in automatic washing machines, more particularly, a water softening device based on capacitive deionisation in a flow-through capacitor for obtaining water that is suitable for use with detergent products having low environmental impact.

### BACKGROUND OF THE INVENTION

In recent years one has become increasingly aware of the impact of human activities on the environment and the negative consequences this may have. Ways to reduce, reuse and recycle resources are becoming more important. Fabric cleaning is one of the many household activities with a significant environmental impact. This is partly caused by the use of conventional detergent products, which tend to be relatively complex compositions with a variety of ingredients. Over the years some ingredients have been banned by legislation in certain countries because of their adverse environmental effects. Examples include certain nonionic surfactants and builders such as phosphates. The use of phosphates in detergents has been linked to increased levels of phosphates in surface waters. The resulting eutrophication is thought to cause an increased growth of algae. The increased algae growth in stagnant surface water leads to oxygen depletion in lower water layers, which in turn causes general reduction of overall water quality.

Although some ingredients in conventional laundry detergent products may have a limited environmental effect, the energy involved in the production thereof influences the environmental impact during their life cycle negatively. Life cycle analysis typically estimates the environmental impact of a product during the different phases such as production of raw material, production of the product itself, distribution to the end user, use of the product by for example the consumer and the disposal after use. Environmental impact may include factors like eutrophication, green house effect, acidification and photo-chemical oxidant formation. With respect to laundry detergent products, extra ingredients necessarily add cost, volume and weight to the product, which in turn requires more packaging material and transport costs. Extra ingredients usually require a more complex production process. However, it is difficult to reduce the number and/or amount of the ingredients without reducing the cleaning efficiency.

One of the most bulky ingredients of common laundry detergents are so-called builders like for example zeolites, phosphates, soaps and carbonates. Builders are added to laundry detergent formulations for their ability to sequester hardness-ions like Ca²⁺ and Mg²⁺. The reduction of hardness ions is required in order to prevent the deposition of calcium soaps in the soil, to prevent the precipitation of anionic surfactants, to maximise colloid stability and to reduce the calcium-soil-substrate-interaction and soil-soil interaction and hence to improve soil removal.

Apart from their positive effects, common builders also may have negative effects on laundry cleaning processes. Builders often generate insoluble materials in the wash either as such or by formation of precipitates. For example, zeolites are insoluble and may cause incrustation of fabrics and precipitates of calcium-builder-complex result in higher redepositioning.

In short, builders are required for sequestering hardness ions to improve wash efficiency, but have a negative environmental effect and generate insoluble precipitates that may cause redepositioning on the fabric articles and thereby reduce the wash efficiency. However, the requirement for builder material may be reduced when soft water is used in the washing process.

Different methods are known in the art to produce soft water by sequestering hardness-ions like Ca²⁺ and Mg²⁺ from tap water, for instance by ion-exchange. In WO01/30229, a system is described, which utilises a built-in ion-exchange system to remove calcium and magnesium ions from the water supply. However, the ion-exchange material requires regular regeneration. For application in a common type of automatic washing machine, vast amounts of e.g. salt solution would be required for the regeneration of the ion-exchanger, thereby undoing the effect of the reduction of builder chemicals in the detergent. Further disadvantages of ion-exchange are the limited life-time of the ion-exchange resin and/or the required volume of resin for the production of the amount of soft water required in a washing machine.

Another water softening method is electronic deionisation (EDI), which combines ion exchange and electrodialysis, as described in co-pending application 04076353.4. Although this method does not require regeneration chemicals, the other disadvantages of the ion-exchange resin remain as indicated above. Furthermore, EDI is a complicated technology, that is difficult to operate in a robust manner over a long time period, as required in house-hold appliances

A known method for water treatment is capacitive deionisation, using a flow through capacitor (FTC) as among others described in U.S. Pat. No. 6,309,532 and WO02/086195. Said method comprises the use of an electrically regenerable electrochemical cell for capacitive deionization and electrochemical purification and regeneration of the electrodes including two end plates, one at each end of the cell. By polarising the cell, ions are removed from the electrolyte and are held in the electric double layers at the electrodes. The cell can be (partially) regenerated electrically to desorb such previously removed ions. The regeneration could be carried out without added chemical substances. In recent publications (US2004/0174657, U.S. Pat. No. 6,778,378, U.S. Pat. No. 6,709,560, U.S. Pat. No. 6,628,505, US2002/0167782) an improved version of the FTC technology, the so-called charge barrier Flow Through Capacitor technology, is presented, showing that a charge barrier placed adjacent to an electrode of a flow-through capacitor can compensate for the pore volume losses caused by adsorption and expulsion of pore volume ions. The term charge barrier refers to a layer of material which is permeable or semi-permeable and is capable of holding an electric charge. Pore volume ions are retained, or trapped, on the side of the charge barrier towards which the like-charged ions migrate. Generally, a charge barrier functions by forming a concentrated layer of ions. The effect of forming a concentrated layer of ions balances out, or compensates for, the losses ordinarily associated with pore volume ions. This effect allows a large increase in ionic efficiency, which in turn allows energy efficient purification of concentrated fluids. Using the charge barrier flow-through capacitor in the purification of water has been observed at an energy level of less than 1 joules per coulomb ions purified, for example, 0.5 joules per coulomb ions purified, with an ionic efficiency of over 90%.

It is an object of the present invention to find a cost-effective method having low environmental impact for removing hardness ions from tap water. It is another object of the invention to find a cost-effective method having low environmental impact both for removing hardness ions from tap water and for modifying the pH. Another object of the present invention is to find a method for removing hardness ions from tap water and for modifying the pH of said water in a manner that is robust, long lasting, convenient and user friendly to consumers. It is a further object of the invention to find a method to remove hardness ions from the tap water, without the need for added chemicals or vast amounts of water. It is another object of the invention to find a method to remove hardness ions from a softening device, without the need for added chemicals or vast amounts of water. Yet another object of the invention is to find a suitable method for treating tap water such that water is obtained that is suitable for use with a low environmental impact detergent product (LEIP, as defined herein), in fabric cleaning methods. A still further object of the invention is to find a cleaning method wherein water obtained from such a water treatment method can be suitably used with a LEIP in in-home cleaning appliances, such as a fabric washing machine.

We have surprisingly found that one or more of these objects can be achieved with the water softening device of the present invention.

### DEFINITION OF THE INVENTION

Accordingly, the present invention provides a water softening device for application in a household appliance comprising a flow-through capacitor for the production of wash amplified water (WAW) from tap water, said WAW having less than 50 FH, and being suitable for use in said appliance when the device is in operation; whereby the configuration of the device is such that the capacitor can be regenerated, whereby no added substances are used; and a pH modifier that can be fed with tap water or softened water, and is able to split this water in an alkaline and an acidic water stream; and wherein the ratio between WAW and waste water from the flow-through capacitor is from 5:1 to 100:1.

The invention also provides a laundering process for the cleaning of fabric articles wherein water softening device 30 according to the invention is used.

The invention further provides a water softening process wherein the device of the invention is used and wherein the anions present in the feed water are attracted to the anode plates and cations in the water are attracted to the cathode plates when the device is in operation.

For the purpose of the present invention, the feed water is defined to be water having a conductivity of more than 50 micro Siemens cm⁻¹, preferably more than 100 micro Siemens cm⁻¹ and more preferably more than 200 micro Siemens cm⁻¹. For practical reasons, the feed water is desirably tap water from the main, having a water hardness of at least 7° FH.

Preferably, the cleaning method of the invention is carried out in a fabric or dish washing machine, more preferably a fabric washing machine. In view of this, it is desirable that the wash amplified water has a pH of above 8.5, more preferably above 9.5.

The cleaning method of the invention is particularly suitable for in-home use and the wash amplified water obtained from said method is suitable for use in a household-cleaning appliance.

These and other aspects, features and advantages will become apparent to those of ordinary skill in the art from a reading of the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Similarly, all percentages are weight/weight percentages of the low environmental detergent product composition unless otherwise indicated. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

The wash amplified water (WAW) that is obtained from the device of the invention is particularly suitable for use in a household-cleaning appliance.

The household appliance may be any device related to cleaning like for example a washing machine, in particular a fabric or dish washing machine. As is known, certain household appliances, in particular dish-washers, are provided with a system, also known as a water decalcifier or softener, for reducing the water hardness. In particular, such a system is provided for reducing the calcium and magnesium contents of the water used for washing purposes, which may inhibit the action of detergents and produce calcareous deposit; in fact, calcareous deposits are due to an excessive amount of calcium ions (Ca²⁺) and magnesium ions (Mg²⁺) contained in the water supplied by the main. Ion exchangers for removing hardness ions (Ca²⁺ and Mg²⁺) from water that are applied in some current dishwashing machines, typically use Na⁺ as so-called replacement ions. Water flows over the resin and the hardness ions in the water are exchanged with the replacement ions on the resin. The resin is exhausted when most replacement ions have been replaced by hardness ions. In order to replenish the resin, also called regenerating the resin, a strong solution of the replenishment ions is generally applied to the resin. In view of the discussion above such a regeneration method is undesirable.

### Flow Through Capacitor

Accordingly, the present invention has amongst others the aim to provide a washing water treatment method in which the feed water is fed through a flow through capacitor (FTC) in order to produce Wash Amplified Water (WAW) having a water hardness of less than 5° FH, and in which the flow through capacitor is regenerated by short-circuiting the poles of the capacitor or by reversing the polarity of the capacitor.

In order to be effective for washing processes, the WAW has a hardness of less than 5° FH, preferably less than 2° FH and more preferably less than 1° FH. The reduction of the water hardness is required in order to prevent the deposition of calcium soaps in the soil, to prevent the precipitation of anionic surfactants, to maximise colloid stability and to reduce the calcium-soil-substrate interaction and soil-soil interaction and hence to improve soil removal.

In order to be suitable for use in a domestic washing machine, the production capacity of WAW is preferably at least 0.5 L/min, more preferably at least 1 L/min, still more preferably at least 2 L/min, even more preferably more than 5 L/min. Although there is no preferred upper limit with regard to the usefulness of the device, the production capacity is typically less than 10 L/min for FTC-units, as currently available in a suitable size to build into a domestic washing machine.

The flow through capacitor (FTC) of the present invention comprises plates having a conductive surface. The plates are chargeable in response to an applied DC potential. The plates are separated from each other by non-conductive spacers. The plates and the conductive surface on the plates may be constructed from conductive materials such as metals, carbon or conductive polymers or combinations thereof, as also described in WO01/66217 or WO02/86195, by Andelman.

The charge barrier FTC as disclosed in WO02/86195 is the most preferred FTC in context of this invention.

When the FTC comprises n plates, n−1 spacers are required;

wherein n is a positive integer; n is at least 2. One part of the plates may be negatively charged by the DC potential and may act as cathode, and the other part may be positively charged and act as anode. The anode plates attract anions from the feed water and the cathode plates attract cations from the feed water when the device is in operation.

Because the plates of the FTC have a limited capacity, the FTC requires regeneration, to remove the hardness ions from the FTC plates. The FTC may be regenerated by flushing with fresh water, short-circuiting the anode plates with the cathode plates or by reversing the polarity or by a combination thereof. The interval for regeneration is also dependent on the concentration of ions in the feed water; the harder the feed water, the more frequent regeneration is required. The water produced during regeneration contains a high level of hardness (ions) and is therefore directed to the waste outlet. The volume ratio between the produced wash amplified water (WAW) and waste water is between 5:1 and 100:1, preferably between 10:1 and 100:1. The FTC thereby provides water softening without the addition of chemicals for regeneration. The required amount of regeneration water may be reduced and the robustness of operation may be improved by regenerating with acidic water instead of tap water.

### pH Modifier

For long lasting robust operation of the FTC device, it is desirable to be able to regenerate the FTC, thereby removing the hardness ions from the FTC plates. By changing the polarity of the poles, or short-circuiting the poles, the FTC may release hardness ions up to a concentration of 10 times as high as in the feed water. This may result in a risk of Ca-deposit formation, which may be detrimental for the long-term stability of the technology. In addition, electrochemically active ions that may be present in tap water (such as copper), do not absorb electrostatically to the carbon, but tend to plate out on the carbon. Even though the concentration of such ions in tap water will generally be low, the build-up over time may cause problems for the performance of the technology. In view of the above, the efficiency of the regeneration may be improved by regenerating with water with low pH. The pH of the feed water may be reduced by the addition of acid, but may preferably be produced in-situ by a pH-modifier. A pH modifier is a device that divides a feed water stream in an acidic and an alkaline stream e.g. in an electrolysis cell. The pH modifier may be fed with tap water or softened water e.g. WAW according to the invention. At least part of the acidic stream may be used for the regeneration of the FTC, whereas the alkaline stream may be added to the product stream to increase the pH of the water in the household appliance. Furthermore, part of the acidic stream may be used in the washing process, for instance during the pre-wash, where a lower pH may be advantageous. The pH of the acidic water is preferably between 1 and 6, more preferably between 1 and 3. The pH of the alkaline stream is typically between 9 and 12, preferably between 10 and 12. The volume ratio between produced alkaline water and acidic water for the application in the device of the invention is preferably between 1:20 and 20:1, more preferably between 1:1 and 20:1.

In order to be suitable for use in a domestic washing machine, the feed water capacity of the pH modifier is preferably at least 0.5 L/min, more preferably at least 1 L/min, still more preferably at least 2 L/min, even more preferably more than 5 L/min. Although there is no preferred upper limit with regard to the usefulness of the device, the feed water capacity of the pH modifier is typically less than 10 L/min for pH-units, as currently available in a suitable size to build into a domestic washing machine.

Washing processes in household appliances such as fabric washing machines and dish washing machines are usually carried out at elevated pH to improve cleaning. The pH of a conventional wash solution is usually kept above 10 to improve fatty and particulate soil removal.

In short, a pH modifier may be used for the production of acidic water for the regeneration of the FTC and for use in the washing process, especially the pre-wash, and alkaline water that may be used in the washing process, thereby improving the robustness of the water softening process, without the addition of chemicals, and reducing the required amount of water for the regeneration of the FTC.

### The Cleaning Method

In the cleaning method of the invention, the wash amplified water may be mixed with a low environmental impact detergent product (LEIP) and used for treating substrates to be cleaned. Said cleaning method is preferably carried out in a fabric washing or a dish washing machine.

### Builders

It is estimated that the majority of laundry detergent products sold in most parts of the world are conventional granular detergent products. These typically comprise more than 15% wt of a builder. Builders are added to improve the detergency but builders such as phosphate are renowned for their effect on eutrophication. To overcome this problem in many countries—in particular those where phosphates are banned, zeolites have become the accepted industry standard. The LEIP used according to the invention is substantially builder-free. Substantially builder-free for the purpose of the present invention means that the LEIP comprises 0 to 5% of builder by weight of the total LEIP composition. Preferably, the LEIP comprises 0 to 3%, more preferably 0 to 1%, most preferably 0% by weight of builder based on the total LEIP composition.

Builder materials are for example 1) calcium sequestrant materials, 2) calcium precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. Nos. 4,144,226 and 4,146,495 and di-picolinic acid and its salts. Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also know as Zeolite P), zeolite Q, zeolite X, zeolite Y and also the zeolite P type as described in EP-A-0384070. In addition polymeric builders like poly-acrylates and poly-maleates. Although soaps may have a builder function for the purpose of the present invention soaps are not considered to be builders but instead surfactants.

### Surfactants

The LEIP used in the cleaning method of the invention comprises at least 10 wt. %, preferably at least 25 wt. % more preferably at least 40 wt. % of a surfactant. For most cases, any surfactant known in the art may be used. The surfactant may comprise one or more anionic, cationic, nonionic, zwitterionic surfactant and mixtures thereof. Further examples are given in “Surface Active Agents and Detergents” (Vol. I and II by Schwartz, Perry and Berch). A variety of such surfactants are also generally disclosed in U.S. Pat. No. 3,929,678.

### pH Modifying Chemicals

Another major ingredient in conventional granular detergent products are pH modifying chemicals. For the purpose of the present invention the term pH modifying chemicals is meant to describe ingredients that affect the pH either by increasing, decreasing or maintaining the pH at a certain level. Typical examples include, but are not limited to, salts like acetates, borates, carbonates, (di) silicates, acids like boric acid, phosphoric acid, sulphuric acid, organic acids like citric acid, bases like NaOH, KOH, organic bases like amines (mono- and tri-ethanol amine). In conventional detergent products builder and pH modifying chemicals may account up to 70 wt. % of the composition. It is to be noted that for the purpose of the present invention surfactants—even though some surfactants may have some pH effect—are not considered to be a pH modifying chemical.

The LEIP according to one preferred embodiment of the invention is substantially free of pH modifying chemicals. Substantially free of pH modifying chemicals is meant to describe products comprising 0 to 5 wt. % of pH modifying chemicals. Preferably the LEIP comprises 0 to 3 wt. %, more preferably 0 to 1 wt. %, most preferably 0 wt. % of pH modifying chemicals by weight of the total LEIP composition.

### Enzymes

Enzymes constitute a preferred component of the LEIP. The selection of enzymes is left to the formulator. However, the examples herein below illustrate the use of enzymes in the LEIP compositions according to the present invention. “Detersive enzyme”, as used herein, means any enzyme having a cleaning, stain removing or otherwise beneficial effect in a LEIP. Preferred enzymes for the present invention include, but are not limited to, inter alia proteases, cellulases, lipases, amylases and peroxidases.

### Enzyme Stabilizing System

The LEIP herein may comprise from about 0.001% to about 10% by weight of the LEIP of an enzyme stabilising system. One embodiment comprises from about 0.005% to about 4% by weight of the LEIP of said stabilising system, while another aspect includes the range from about 0.01% to about 3% by weight of the LEIP of an enzyme stabilising system. The enzyme stabilising system can be any stabilising system which is compatible with the detersive enzyme. Stabilising systems can, for example, comprise calcium ion, boric acid, propylene glycol, short chain carboxylic acids, boronic acids, and mixtures thereof, and are designed to address different stabilisation problems depending on the type and physical form of the detergent composition.

### Bleaching System

The LEIP composition used in the method of the present invention may optionally include a bleaching system. Non-limiting examples of bleaching systems include hypohalite bleaches, peroxygen bleaching systems with or without an organic and/or transition metal catalyst, or transition metal nil peroxygen systems. Peroxygen systems typically comprise a “bleaching agent” (source of hydrogen peroxide) and an “activator” and/or “catalyst”, however, pre-formed bleaching agents are included. Catalysts for peroxygen systems can include transition metal systems. In addition, certain transition metal complexes are capable of providing a bleaching system without the presence of a source of hydrogen peroxide.

### Optional Cleaning Agents

The LEIP may contain one or more optional cleaning agents, which include any agent suitable for enhancing the cleaning, appearance, condition and/or garment care. Generally, the optional cleaning agent may be present in the compositions of the invention in an amount of about 0 to 20 wt. %, preferably 0.001 wt. % to 10 wt. %, more preferably 0.01 wt. % to 5 wt. % by weight of the total LEIP composition.

Some suitable optional cleaning agents include, but are not limited to antibacterial agents, colorants, perfumes, pro-perfumes, finishing aids, lime soap dispersants, composition malodour control agents, odour neutralisers, polymeric dye transfer inhibiting agents, crystal growth inhibitors, anti-tarnishing agents, anti-microbial agents, anti-oxidants, anti-redeposition agents, soil release polymers, thickeners, abrasives, corrosion inhibitors, suds stabilising polymers, process aids, fabric softening agents, optical brighteners, hydrotropes, suds or foam suppressors, suds or foam boosters, anti-static agents, dye fixatives, dye abrasion inhibitors, wrinkle reduction agents, wrinkle resistance agents, soil repellency agents, sunscreen agents, anti-fade agents, and mixtures thereof.

### Product Format

The LEIP may be dosed in any suitable format such as a liquid, gel, paste, tablet or sachet. In some cases granular formulations may be used although this is not preferred. In one preferred embodiment the LEIP is a non-aqueous product. Non-aqueous for the purpose of the present invention is meant to describe a product comprising less than 10%, preferably less than 5%, more preferably less than 3% by weight of free water. The non-aqueous product may be a liquid, gel or paste or encapsulated in a sachet.

It is desirable to equip washing machines with one or more detergent product containers so that the detergent product may be dosed automatically. The LEIP may be dosed from a single container. Alternatively, the ingredients making up the LEIP may be dosed from separate containers as described in EP-A-0419036. Thus in one preferred embodiment at least one ingredient from the LEIP is dosed automatically. One advantage of a LEIP may be that the reduced number and/or amount of ingredients enables a much smaller volume of detergent product. In practice this would mean that the consumer does not need to refill the containers as often or that the containers may be smaller, therefore making an automatic dosage system more feasible when using the device of the invention.

### DESCRIPTION OF THE FIGURES

FIG. 1 shows a flow diagram of a preferred embodiment of the device of the invention and

FIG. 2 shows the working of an electrolysis cell as pH modifier.

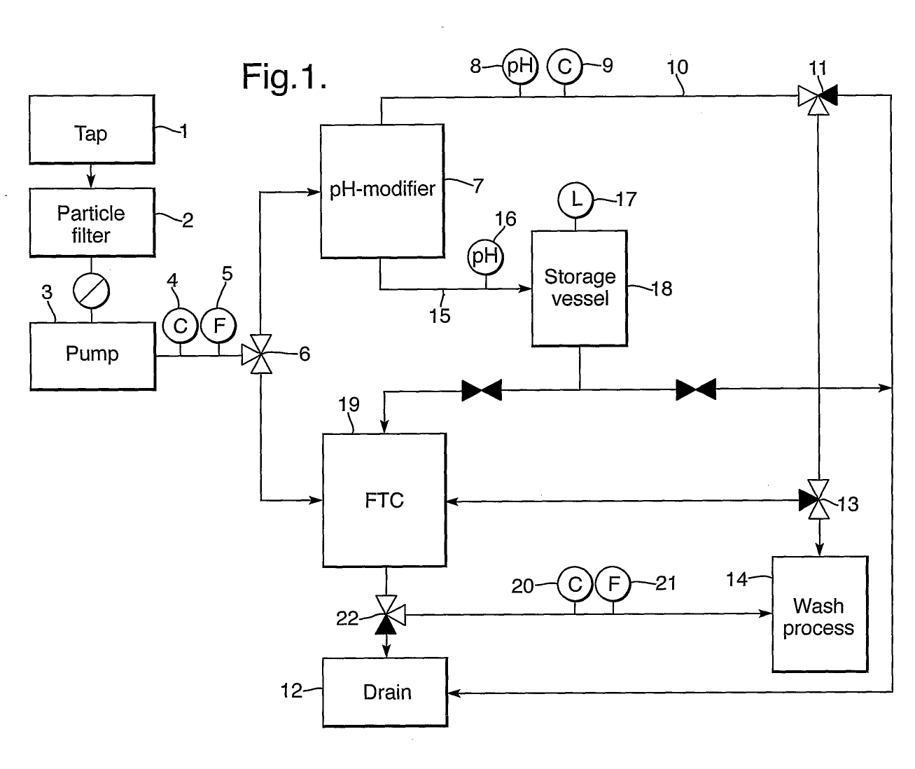

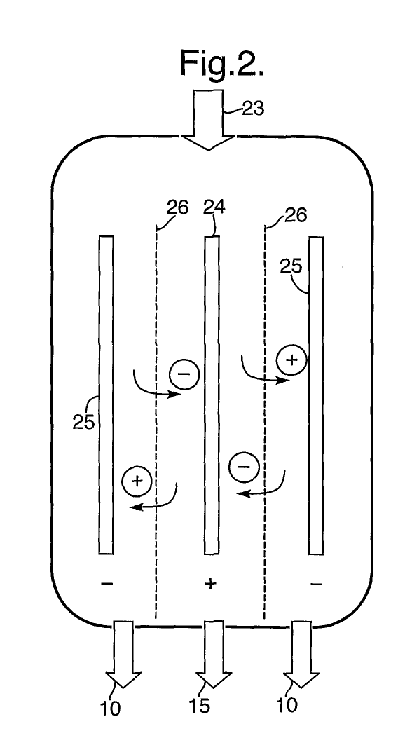

In FIG. 1, tap water (1) from the main is fed to a particle filter (2). A pump (3) and a distributor valve (6) distribute the tap water to the FTC (19) and the pH modifier (7, electrolysis cell), via a conductivity sensor (4) and a flow meter (5). The alkaline stream (10) from the pH modifier is passed through a pH monitor (8) and conductivity cell (9) to valve (11), that directs the alkaline water to the washing process (14) via valve (13) or to the drain (12). The acidic stream (15) from the pH modifier (7) is passed via a pH sensor (16) and is stored in a storage vessel (18) with level sensor (17). From storage vessel (18) the acidic water may be passed to the FTC (19) for regeneration or to the drain (12). The water that is passed to the FTC (19) by the pump (3) and valve (6) is softened in the FTC and is transported to the washing process (14) via a valve (22) passing conductivity meter (20) and flowmeter (21). Valve (13) may also be used to pass the FTC product to the washing process. Excess water from the FTC can be drained through valve (22). In FIG. 2 an electrolysis cell, suitable as pH modifier is schematically depicted. Water (23) is fed to the cell. Inside the cell of FIG. 2 are two cathodes (25) and one anode (24) separated by a non-conductive spacer (26). When in operation, alkaline water (10) is produced at the cathodes and acidic water (15) at the anode.

### EXAMPLES

The invention will now be illustrated by way of the following non-limiting examples, in which all parts and percentages are by weight unless otherwise indicated.

### Example 1

### Flow Through Capacitor

A sequence of a number of water softening steps under different conditions was carried out using a commercially available Flow Through Capacitor technology (Electronic Water Purifier (EWP), by Sabrex, Inc., San Antonio, Tex., USA). The equipment was used at its normal operation sequence of a water purification stage (250 ml) and a regeneration stage (150 ml). The water hardness in the various samples was determined by Inductively Coupled Plasma (ICP) spectroscopy.

At first the FTC unit was operated with regular Vlaardingen tap water (16.5° FH) for a period of 8 hours. During this time period the average hardness in the product stream was 0.2° FH whereas the average hardness in the regeneration waste stream was 43° FH (Table 1).

After 8 hours the FTC unit was operated with a feed of demi-water (demineralised water with a hardness of 0° FH) as feed for three consecutive cycles of purification and regeneration. The average hardness in the product stream was 0° FH whereas the average hardness in the regeneration stream (waste) was 1.1° FH (Table 1).

After the demi-water operation, the FTC unit was operated with a feed of demi-water with a pH adjusted to 3.5 with hydrochloric acid (HCl). The FTC was operated for three consecutive cycles of purification and regeneration. The average hardness in the product stream was now 0° FH whereas the average hardness in the regeneration stream (waste) was 2.8° FH (table 1).

Finally, the FTC unit was operated with a feed of demi-water at pH 2.0 (adjusted with hydrochloric acid) for three consecutive cycles of purification and regeneration. The average hardness in the product stream was now 0.7° FH whereas the average hardness in the regeneration stream (waste) was 66° FH (Table 1).

Based on the results presented in this example it can be concluded that already after 8 h of operation a significant amount of Ca has deposited on the electrodes of the FTC unit of which only a very small part can be removed in demi water. However, when the regeneration step is carried out at pH 3.5, already a clear increase in the hardness of the regeneration stream is observed whereas regeneration with water at pH 2 results (Table 1) in a large additional removal of hardness from the FTC.

TABLE 1
hardness of the feed, product and regeneration
streams from the FTC unit

| | Feed | Product | Regeneration |
|---|---|---|---|
| | Hardness | Hardness | Hardness |
| | [° FH] | [° FH] | [° FH] |
| Tap water operation | 16.5 | 0.2 | 43 |
| Demi water operation | 0.0 | 0.0 | 1.1 |
| Demi water op. (pH = 3.5) | 0.0 | 0.0 | 2.8 |
| Demi water op. (pH = 2.0) | 0.0 | 0.7 | 66 |

The results show that the long-term durability and robustness of FTC, which is desirable for application in washing machines, is strongly enhanced by regeneration at reduced pH, by improved removal of the hardness ions.

### Example 2

### pH Modifier

Using an electrolysis cell, tap water was split into an acidic and an alkaline product stream. The lay-out of the electrolysis cell used in this example is similar to the cell described in FIG. 2. In this case however, the cell consisted of three cathodes and two anodes (hence four electrode pairs) to increase the total electrode surface area and hence the capacity. The electrode dimensions were approximately 12 by 6 cm per electrode and made of stainless steel with a Ruthenium-Iridium coating. The applied voltage over the electrodes was 42 V.

The flow rate entering the cell was approximately 100 L h⁻¹ with a total volume of about 2 L. The volume ratio between the alkaline and the acidic product flow was about 9:1. The pH of the alkaline product stream was approximately 11 and the pH of the acidic product stream was approximately 2.

### Example 3 and Comparative Examples A and B

### Wash Process

About 15 L of WAW (˜0.2° FH, pH 8) and about 1 L of alkaline water from the pH modifier (˜16.5° FH, pH 11) were used resulting in water of ˜1.0° FH, pH 10). LEIP was pre-dissolved in 1 L of said WAW and added to a Miele W765 automatic washing machine together with the remaining WAW and alkaline water from the pH modifier. The predissolved LEIP consisted of NaLAS (>95% pure, ex. Degussa Huls) in a concentration of 1.0 g L⁻¹, Savinase 12TXT (ex. Novozymes) in a concentration of 0.05 g L⁻¹ and foam depressor DC8010 (ex. Dow) in a concentration of 12 mg L⁻¹ in solution.

The load consisted of 3 kg of clean cotton and 4 swatches of each of the following soil monitors (acquired from CFT bv., Vlaardingen, The Netherlands).

M002 (Grass on cotton)
WFK 10D (Sebum on cotton)
CS-216 (diluted lipstick on cotton)
EMPA 106 (carbon black/mineral oil on cotton)
AS-9 (Pigment/oil/milk on cotton)

The load was washed at a temperature of 40° C. using the normal ‘whites wash program’ on the washing machine.

Comparative example A was carried out using 16 L of Vlaardingen tap water in stead of WAW using the same LEIP and a similar wash load and wash program.

Comparative example B was carried out using 16 L of Vlaardingen tap water and ˜4 g L⁻¹ of a commercial detergent product (Composition ˜15% surfactants, ˜25% zeolite builder, ˜55% buffers, ˜0.5% enzymes and ˜4.5% other minors like polymers). A similar wash load and wash program were used.

The corresponding cleaning results for the various soil monitors in the three wash experiments are shown in Table 2. The stain removal performance (extent of cleaning) was measured with a reflectometer (X-Rite XR968). In the reflectometer, light is directed at the surface of the sample at a defined angle and the reflected light is measured photoelectrically. The reflected light is expressed as a percentage (% R) at a wavelength of 460 nm. The cleaning results are expressed as ‘Delta R’, which is the difference in reflectance of the soil monitors after and before the washing cycle, as measured with the reflectometer at 460 nm.

TABLE 2

| | | Comp. | Comp. |
|---|---|---|---|
| | Example 1 | Example A | Example B |
| Soiled materials | (Delta R) | (Delta R) | (Delta R) |
| Carbon black- mineral oil on | 19 | 12 | 19 |
| cotton (EMPA 106) | | | |
| Sebum on cotton (WFK 10D) | 22 | 15 | 24 |
| Grass on cotton (M002) | 42 | 25 | 45 |
| Pigment/oil on cotton (AS-9) | 27 | 17 | 26 |
| Diluted lipstick on cotton | 22 | 23 | 30 |
| (CS-216) | | | |

It can be derived from the above table, that the cleaning results of the LEIP in combination with WAW are significantly better than the cleaning results of the LEIP in regular tap water. The cleaning result of the LEIP in combination with the WAW is even comparable to that of a commercial detergent in tap water (comparative example B), even though the amount of commercial detergent used in comparative example B (i.e. 4.0 g/L) is about 4 times higher than the amount of LEIP used in example 3 (i.e. 1.06 g/L).

1. A water softening device for application in a household appliance comprising:
(a) a flow-through capacitor for the production of wash amplified water (WAW) from tap water, said WAW having less than 5° FH, and being suitable for use in said appliance when the device is in operation; whereby the configuration of the device is such that the capacitor can be regenerated, whereby no added substances are used; and
(b) a pH modifier that can be fed with tap water or softened water, and is able to split this water in an alkaline and an acidic water stream; and
wherein the ratio between WAW and waste water from the flow-through capacitor is from 5:1 to 100:1.

2. A water softening device according to claim 1, wherein the flow-through capacitor comprises
(a) ‘n’ plates comprising a conductive surface and chargeable in response to an applied DC potential, and
(b) ‘n−1’ non-conductive spacers to separate said plates from each other, wherein n is a positive integer, n being at least 2.

3. A water softening device according to claim 2, wherein part of the plates are negatively charged by a DC potential and act as cathode and part of the plates are positively charged and act as anode.

4. A water softening device according to claim 1, wherein the pH modifier comprises an electrolysis cell.

5. A water softening process wherein the device of claim 2, wherein the anions present in the feed water are attracted to the anode plates and cations in the water are attracted to the cathode plates when the device is in operation.

6. A water softening process wherein the device of claim 2 is used and, wherein the plates are regenerated by a suitable combination of the steps of:
(a) loading with fresh water; and
(b) short-circuiting the anode plates with the cathode plates of the capacitor or reversing the polarity of the DC potential.

7. A water softening process using the device of claim 1, wherein:
(a) at least part of the acidic water stream is used in the flow-through capacitor during regeneration; and
(b) the alkaline water stream is used in the household appliance, thereby increasing the pH of the washing liquor used therein.

8. A water softening process according to claim 5, wherein the acidic water has a pH of 1 to 6, preferably 1 to 3.

9. A water softening process according to claim 5, part of the acidic water stream is used in the washing process.

10. A water softening device according to claim 1, wherein the household appliance comprises an automatic dosage system for detergent compositions.

11. A water softening device according to claim 1 wherein the household appliance is an automatic fabric washing machine.

12. A water softening device according to claim 1 wherein the household appliance is an automatic dish washing machine.

13. A laundering process for the cleaning of fabric articles wherein water softening device according to claim 1 is used.

14. A laundering process according to claim 13, wherein a low environmental impact detergent product (LEIP) is applied.

15. A laundering process according to claim 13 wherein the LEIP comprises 0 to 5% by weight of builder material.
